(19) United States
(12) Patent Application Publication
(10) Pub. No.: US 2021/0384594 A1
(43) Pub. Date: Dec. 9, 2021

(54) INSERTION PART FOR INSERTION INTO A BATTERY HOUSING OF A BATTERY SYSTEM ARRANGEMENT, AND BATTERY SYSTEM ARRANGEMENT

(71) Applicant: WEBASTO SE, Stockdorf (DE)

(72) Inventors: Michael SCHÖNEBERGER, Stockdorf (DE); Jochen HAUSSMANN, Stockdorf (DE)

(21) Appl. No.: 17/283,856

(22) PCT Filed: Oct. 15, 2019
(86) PCT No.: PCT/EP2019/077907

§ 371 Date: Apr. 8, 2021

(30) Foreign Application Priority Data
Oct. 15, 2018 (DE) 10 2018 125 457.1

(51) Int. Cl. H01M 50/572; H01M 50/30; H01M 10/658; H01M 50/505; H01M 50/24

(52) U.S. Cl. CPC H01M 50/572; H01M 50/30; H01M 2220/20; H01M 50/505; H01M 50/24; H01M 10/658

(57) ABSTRACT

An insertion part for insertion into a battery housing of a battery system arrangement includes a base body that is embodied from an electrically insulating material, including a functional insert that is positioned in the base body and integrated therein.

### CROSS REFERENCE TO RELATED APPLICATIONS

This application is a national stage of International Application No. PCT/EP2019/077907 filed Oct. 15, 2019, which claims priority from German Patent Application 10 2018 125 457.1 filed Oct. 15, 2018 in the German Patent and Trademark Office, the disclosures of which are incorporated herein by reference in their entirety.

### BACKGROUND

### Technical Area

The present invention relates to an insertion part for insertion into a battery housing of a battery system arrangement, and a battery system arrangement.

### Related Art

In order to protect energy-storage components of a battery, in particular of a vehicle battery, against environmental influences, such as for example moisture or mechanical influences, it is known to house these modules and components in a battery housing.

Vehicle batteries generally comprise a plurality of battery modules that are arranged inside the battery housing. In order to ensure a functional and structural integrity of the battery, these modules are to be connected to one another in an electrical manner and mechanically fixed.

In order to facilitate this, vehicle batteries are known in which the housing cover and/or the housing base comprises a functional integration, for example in order to render it possible to position the modules with respect to one another by means of receiving devices that are formed especially in the base or to provide a gas pressure relief valve in the cover.

Vehicle batteries of this type, in which either the housing cover or the housing base comprise a previously described functional integration are known for example from DE 10 2016 219 993 A1, DE 10 2010 043 899 A1 or DE 10 2016 015 029 A1.

However, it is still necessary in known vehicle batteries to insert in addition a multiplicity of individual functional elements, wherein the insertion procedure is often performed by hand, such as electrically contacting individual battery modules or connecting the bus bars necessary for this to a bus bar for high voltage applications. The individual functional elements are in this case to be inserted and positioned part for part into the open housing and fixed using additional connecting elements.

In the case of conventional vehicle batteries, the aforementioned individual elements or rather individual parts are to be provided individually for insertion and moreover attached, correctly positioned and connected to one another by a worker during the production process.

In particular individual components for high voltage applications must be insulated separately owing to this type of handling. Since the worker has to also directly handle components for high voltage applications in order to position and fix these components, the worker is sometimes exposed to high voltages and this necessitates a high degree of safety-at-work provisions.

### SUMMARY

Accordingly, an insertion part for insertion into a battery housing of a battery system arrangement is proposed, comprising a base body that is embodied from an electrically insulating material. In accordance with the invention, the insertion part comprises a functional insert that is positioned in the base body and is integrated therein.

By virtue of the fact that a functional insert is positioned and integrated in the base body, it is no longer necessary for all the individual parts that are to be inserted during the procedure of assembling the battery system arrangement prior to closing the housing to be organized individually, positioned and accordingly attached or rather connected to other components of the battery system arrangement. The insertion part consequently renders it possible to simplify the assembly procedure of such a battery system arrangement and the necessary assembly time required for this can be reduced.

By virtue of positioning the functional insert in the base body, the functional insert is already held in its predetermined position after the insert part has been inserted into the open battery housing. By virtue of integrating the functional insert, it is insured that the functional insert also remains in the predetermined position. Moreover, it is possible by virtue of integrating the functional insert in the base body to prevent a worker being able to come in direct contact with the functional insert, for example in the event that the worker performs an inadvertent movement in the open battery housing. Accordingly, the safety-at-work provision for the worker is significantly increased by virtue of integrating the functional insert in the base body.

In accordance with a further embodiment, the functional insert is configured for performing at least one mechanical and/or thermal and/or electrical function in a battery system arrangement. As a consequence, it is substantially possible to realize the aforementioned function or functions merely by inserting the insertion part into the open battery housing without any comprehensive additional work being required.

If the functional insert is an electrically conductive bus bar, for example for high voltage applications, wherein the bus bar is generally enclosed in the base body except for predetermined contacting sections so as to make electrical contact, as can be the case in accordance with a further embodiment, the safety-at-work provision in particular is increased for a worker who is assembling the battery system arrangement. The bus bar can namely only be contacted at the sites provided for this purpose, at the contacting sections. Apart from that, the bus bar is electrically insulated by means of the electrically insulating material of the base body.

Alternatively or in addition, a functional insert can be a seal for providing a sealing arrangement of a battery housing. As a consequence, the additional work step of inserting a seal that is necessary to seal the battery housing is omitted. Moreover, it is possible to prevent the sealing arrangement of the battery housing developing a leakage region owing to the seal being incorrectly inserted or the seal displacing during the further assembly of the battery system arrangement.

In one embodiment, a functional insert can alternatively or in addition be embodied in the form of a wiring harness guide and/or a wiring harness for a low voltage application. In particular the complex procedures of routing and bringing together cables in the battery housing can be significantly simplified.

In order inter alia to render it possible to collect or discharge moisture, condensed fluid or water that has penetrated, a functional insert can be embodied in addition or alternatively as a drip edge and/or a drip duct.

If a functional insert is alternatively or in addition generally a barrier layer film for forming a condensate barrier, it is possible to prevent condensate from passing into moisture-sensitive regions of the battery.

Alternatively or in addition, a functional insert can be typically embodied in the form of a cavity for receiving a drying bag or can be embodied as a drying bag. As a consequence, it is possible to receive or collect moisture that is present in the battery housing or has penetrated the battery housing in order thus to keep the atmosphere in the interior of the battery housing dry.

If in accordance with a further embodiment, the functional insert is embodied alternatively or in addition in the form of a gas discharge duct for discharging gas, then it is possible in the event of an increase in pressure or in the event of gas forming in the interior of the battery housing to prevent the battery system arrangement becoming damaged owing to the increase in the pressure or the formation of gas. The gas that is formed or the gas or gas mixture that expands as a result of the increase in pressure can be discharged via the gas discharge duct, generally to an optionally provided relief valve, for example in the form of a pressure relief valve.

In accordance with a further embodiment, the functional insert can be embodied in addition or alternatively in the form of a ventilation duct for providing communication with a drying bag. As a consequence, it is possible for moist air that is present in the battery housing or for moisture that has penetrated the battery housing to be conveyed into a drying bag or for such moisture to pass into a drying bag.

In order to prevent one or more further components becoming damaged in the event of fire damage or glimmer damage to a component of the battery system arrangement, the functional insert can generally alternatively or in addition be embodied in the form of a cavity for receiving a fire barrier, such as a glimmer plate, or said functional insert can be embodied as a fire barrier. The glimmer plate can typically be arranged in such a manner that when it is in the installed position in the battery system arrangement in a vehicle it is located between the battery modules and a passenger compartment of the vehicle. As a consequence, it is possible in the event of a fire breaking out in one battery module to prevent flames travelling from the module into the passenger compartment and injuring any persons located therein.

If the functional insert is embodied alternatively or in addition generally in the form of a guide for tools for high voltage applications, it is possible to reduce costs concerning an additional insulation of components for high voltage applications or even to completely avoid such costs. The guide can prevent a worker from otherwise accessing the components for high voltage applications.

In accordance with a further embodiment, at least two functional inserts are received in the base body. As a consequence, it is possible to further reduce assembly costs and to further improve the safety-at-work provisions. In some embodiments, a multiplicity of functional inserts is received in the base body. The advantages and effects described above in relation to the individual embodiments of a functional insert can thus be combined in a purposeful manner.

In accordance with a further embodiment, the outer contour of the base body is adapted at least in sections to suit the shape of at least one component of the battery system arrangement, generally to suit the inner shape of the battery housing, wherein the base body typically comprises multiple regions which have an outer contour that is adapted to suit different components of the battery system arrangement. As a consequence, the insert can be supported directly on the component or on the battery housing. Moreover, it is consequently possible to hold one or more components of the battery system arrangement in a fixed position relative to the battery housing.

If the base body in accordance with a further embodiment has material sections of different thicknesses, it is possible on the one hand for the insertion part to be of a particularly light weight. Moreover, the mechanical load capability or the electrical and/or thermal insulating characteristics of the material sections can be adapted to suit the respective current requirements for a material section. In various embodiments, such an insertion part can be produced by means of a low pressure system using variable foams.

A particularly advantageous production procedure or particularly advantageous material characteristics of the insertion part can be realized if the base body is embodied from a polymer material, for example a foamed polymer material, particularly a substantially closed-cell foamed polymer material, such as polyurethane (PU), thermoplastic elastomer (TPE), polyphenylene ether (PPE) and/or expanded polypropylene (EPP).

In accordance with a further embodiment, the base body is embodied for filling hollow spaces between components and the housing inner wall of the battery housing of the battery system arrangement. As a consequence, it is possible on the one hand to improve the structural stability of the battery system arrangement. Moreover, it is thus possible to reliably position and hold components of the battery system arrangement relative to one another and relative to the battery housing. Moreover, it is thus possible to provide an improved electrical and/or thermal insulation.

If the base body in accordance with one embodiment comprises a positioning region that is embodied in such a manner that the base body can only be inserted into the battery system arrangement in a predetermined orientation, it is possible to prevent the insertion part being incorrectly assembled. The insertion part can consequently only be inserted in precisely one orientation, i.e. the predetermined orientation.

Accordingly, a battery system arrangement is proposed that comprises a battery housing and a plurality of battery components, in particular battery modules, which are received in the battery housing. Moreover, an insertion part in accordance with one of the above mentioned claims is inserted into the battery housing, wherein a functional insert interacts with at least one battery component.

By virtue of the fact that an insertion part in accordance with one of the above mentioned claims is inserted into the battery housing and a functional insert interacts with at least one battery component, the advantages and effects that are described with respect to the insertion part can be realized in a similar manner.

Further advantages and features of the present invention are apparent in the following description of exemplary embodiments. The features described therein can be implemented as stand alone or in combination with one or more of the above illustrated features insofar as the features do not counteract one another. Exemplary embodiments are described below with reference to the accompanying drawings.

### BRIEF DESCRIPTION OF THE FIGURES

Further embodiments of the invention are explained in detail by the description of the figures.

FIG. 1 illustrates schematically a perspective lateral view of an insertion part in accordance with the invention;

FIG. 2 illustrates schematically a plan view of a part of the insertion part shown in FIG. 1;

FIG. 3 illustrates schematically a sectional view through a battery system arrangement in accordance with the invention; and

FIG. 4 illustrates schematically a sectional view through a battery system arrangement in accordance with a further embodiment.

### DETAILED DESCRIPTION

Exemplary embodiments are described below with reference to the figures. In so doing, like, similar or like-functioning elements are provided in the different figures with identical reference signs, and in part a repeated description of these elements is not provided in order to avoid redundancies.

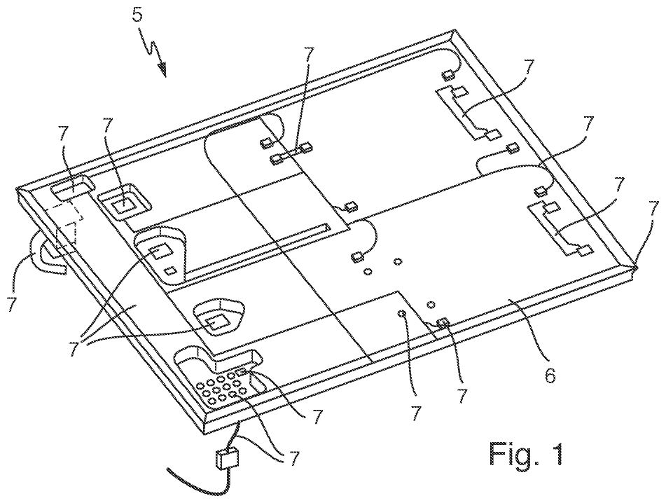

FIG. 1 illustrates schematically a perspective lateral view of an insertion part 5 in accordance with the invention. The insertion part 5 comprises a base body 6 that is embodied from an electrically insulating material. In the present case, the base body 6 is embodied from a foamed polymer material, in this case foamed PU. Alternatively, the base body can also be embodied from a different foamed polymer material, in particular TPE, PPE or EPP.

A plurality of functional inserts 7 is positioned in the base body 6 and integrated therein.

One of the functional inserts 7 is embodied in this case an as electrically conductive bus bar for high voltage applications. The bus bar is embedded or integrated into the base body 6 except for predetermined contacting sections for electrical contacting. A further functional insert 7 is a wiring harness for low voltage applications. A still further functional insert 7 is embodied as a drip edge. Moreover, one of the functional inserts 7 is embodied in the form of a guide for tools for high voltage applications.

Moreover, functional inserts can be provided alternatively or in addition in the base body 6 which can be embodied in particular as a seal for providing a sealing arrangement of a battery housing, as a wiring harness guide and/or a wiring harness for low voltage applications, as a drip duct, a barrier layer film for forming a condensate barrier, a cavity for receiving a drying bag or as a drying bag, a gas discharge duct for discharging gas, a ventilation duct for providing communication with a drying bag or as a cavity for receiving a fire barrier, for example a glimmer plate, or can be embodied as a fire barrier.

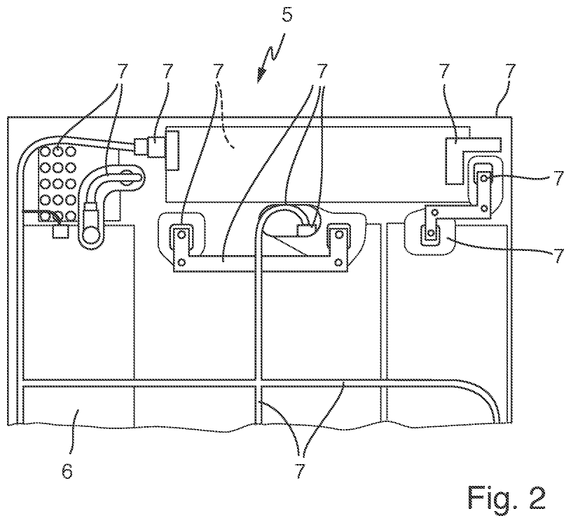

FIG. 2 illustrates schematically a plan view of a part of the insertion part 4 shown in FIG. 1 in which the functional inserts 7 are once again clearly visible.

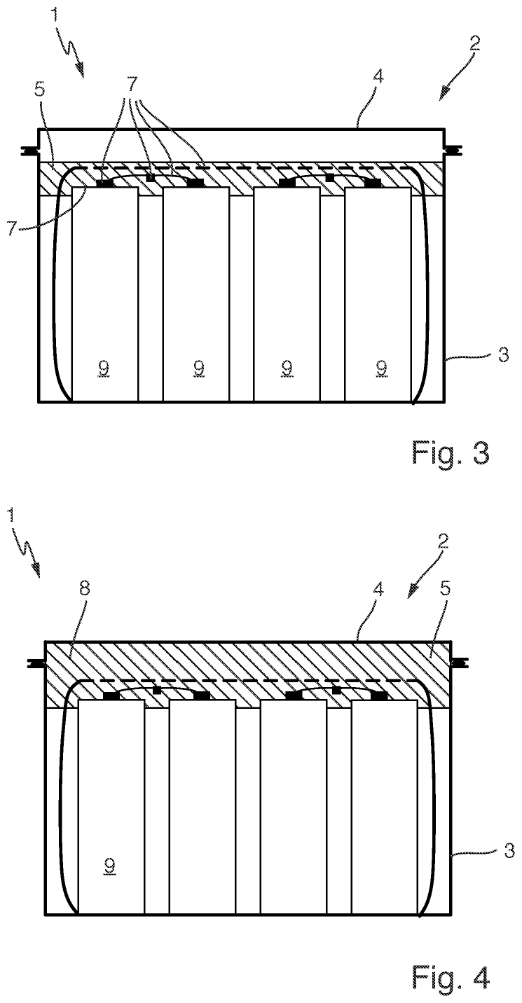

FIG. 3 illustrates schematically a sectional view through a battery system arrangement 1 in accordance with the invention. The battery system arrangement 1 comprises a battery housing 2 that comprises a shell 3 and a cover 4, wherein the cover 4 is connected in a sealed manner to the shell 3 with the result that the battery housing 2 is substantially sealed with respect to the environment. A plurality of battery modules 9 are arranged in the interior of the battery housing 2. Above the battery modules 9, an insertion part 5 in accordance with FIGS. 1 and 2 is inserted from above onto the battery module 9 into the battery housing 2. The functional inserts 7 of the insertion part 5 fulfill in this case different functional tasks, such as electrically contacting the battery modules 9 with the result that it is possible to forego additional individual parts which would otherwise be required for assembling the battery system arrangement 1.

FIG. 4 illustrates schematically a sectional view through a battery system arrangement 1 in accordance with a further embodiment. The battery system arrangement 1 substantially corresponds to that which is illustrated in FIG. 3. In this embodiment, by means of the insertion part 5, a hollow space 8 that extends between the battery modules 9 and the cover 4 in the battery housing 2 is substantially filled by means of the insertion part 5.

Where applicable, all individual features that are illustrated in the exemplary embodiments can be combined with one another and/or exchanged without abandoning the scope of the invention

1-10. (canceled)

11. An insertion part for insertion into a battery housing of a battery system arrangement comprising a base body, wherein the base body is formed from an electrically insulating material and comprises a functional insert that is positioned in the base body and integrated therein.

12. The insertion part of claim 11, wherein the functional insert is configured to perform at least one mechanical, thermal, and/or electrical function in the battery system arrangement.

13. The insertion part of claim 11, wherein the functional insert comprises an electrically conductive bus bar.

14. The insertion part of claim 13, wherein the electrically conductive bus bar is enclosed in the base body except for predetermined contacting sections configured to electrically contact a battery module.

15. The insertion part of claim 11, wherein the functional insert comprises a seal configured to provide a sealing arrangement for the battery housing.

16. The insertion part of claim 11, wherein the functional insert comprises a wiring harness guide and/or a wiring harness.

17. The insertion part of claim 11, wherein the functional insert is formed as a drip edge and/or a drip duct.

18. The insertion part of claim 11, wherein the functional insert comprises a barrier layer film configured to form a condensate barrier.

19. The insertion part of claim 11, wherein the functional insert is formed as a drying bag or a cavity configured to receive a drying bag.

20. The insertion part of claim 11, wherein the functional insert is formed as a gas discharge duct configured to discharge gas.

21. The insertion part of claim 11, wherein the functional insert is formed as a ventilation duct configured to enable a communication with a drying bag.

22. The insertion part of claim 11, wherein the functional insert is formed as a fire barrier or as a cavity configured to receive a fire barrier.

23. The insertion part of claim 11, wherein the functional insert is formed as a tool guide.

24. The insertion part of claim 11, wherein the functional insert comprises at least two functional inserts that are received in the base body.

25. The insertion part of claim 11, wherein an outer contour of the base body is adapted at least in a section to suit a shape of at least one component of the battery system arrangement.

26. The insertion part of claim 11, wherein the base body comprises sections of different thicknesses.

27. The insertion part of claim 11, wherein the electrically insulating material comprises a foamed polymer material.

28. The insertion part of claim 11, wherein the base body is configured to fill hollow spaces between components of the battery system arrangement and an inner wall of the battery housing.

29. The insertion part of claim 11, wherein the base body comprises a positioning region that is configured to be inserted into the battery system arrangement in a predetermined orientation.

30. A battery system arrangement comprising:
a battery housing; and
a plurality of battery components received in the battery housing,
wherein the battery housing comprises an insertion part, the insertion part comprises a base body, and the base body comprises a functional insert that is positioned in the base body and integrated therein.
